(19) United States
(12) Patent Application Publication
(10) Pub. No.: US 2004/0088824 A1
(43) Pub. Date: May 13, 2004

(54) Tool handle having magnetic pieces received therein

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/289,250

(22) Filed: Nov. 7, 2002

(51) Int. Cl. B25G 1/00

(52) U.S. Cl. 16/111.1

(57) ABSTRACT

A handle of a hand tool includes at least one recess defined in an outer periphery of the handle and a magnetic piece is received in the at least one recess. An outer layer is mounted to the handle to enclose the handle and the magnetic piece. The hand tool can be easily positioned by being attracted on a metal floor or board by the magnetic piece.

### FIELD OF THE INVENTION

The present invention relates to a tool handle that has at least one magnetic piece embedded therein so that the tool can be easily attracted on a metal surface.

### BACKGROUND OF THE INVENTION

A conventional hand tool such as a screw driver generally includes a handle and a shank which is fixedly connected to an end of the handle. The users hold the handle to tighten or loosen a screw by rotating the shank. The hand tools are always put randomly on the floor during working and the floor become to be messy. In specific work site, there is no enough room to allow these tools to be put randomly so that the users have to put back to a pouch or the like every time when switching the tools. This consumes time and reduces efficiency of the work. Some handles have magnetic pieces connected thereto by way of gluing. The magnetic pieces protrude from the outer periphery of the handle and could be dispatched from the handle because impact to the magnetic pieces. Besides, the magnetic pieces are black and the color is not the same as the handle's so that this combination lacks of attraction.

The present invention intends to provide a handle of a hand tool and includes recesses in the handle to receive magnetic pieces therein and an outer layer is mounted onto the handle.

### SUMMARY OF THE INVENTION

In accordance with one aspect of the present invention, there is provided a handle of a hand tool and the handle comprises at least one recess defined in an outer periphery of the handle and a magnetic piece is received in the at least one recess. An outer layer is mounted to the handle to enclose the handle and the magnetic piece.

The primary object of the present invention is to provide a handle for a hand tool wherein a magnetic piece is embedded in the handle and an outer layer is wrapped on the handle so that the magnetic piece is protected and the color of the outer layer is made as desired.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a male mold and a female mold for making the handle of the present invention;

FIG. 2 is a cross sectional view to show an outer layer is located between the male mold and the female mold of the present invention;

FIG. 3 shows another embodiment of a male mold and a female mold for making the handle of the present invention;

FIG. 4 is a cross sectional view to show an outer layer is located between the male mold and the female mold of the present invention as shown in FIG. 3;

FIG. 5 is a perspective view to show the handle of the present invention;

FIG. 6 shows another embodiment of the handle of the present invention;

FIG. 7 shows yet another embodiment of the handle of the present invention;

FIG. 8 shows a cross sectional view of the handle of the present invention as shown in FIG. 7;

FIG. 9 shows the handles are attracted at the periphery thereof, and

FIG. 10 shows the handles are attracted at the bottom thereof.

### DETAILED DESCRIPTION OF THE PREFERRED EMBODIMENTS

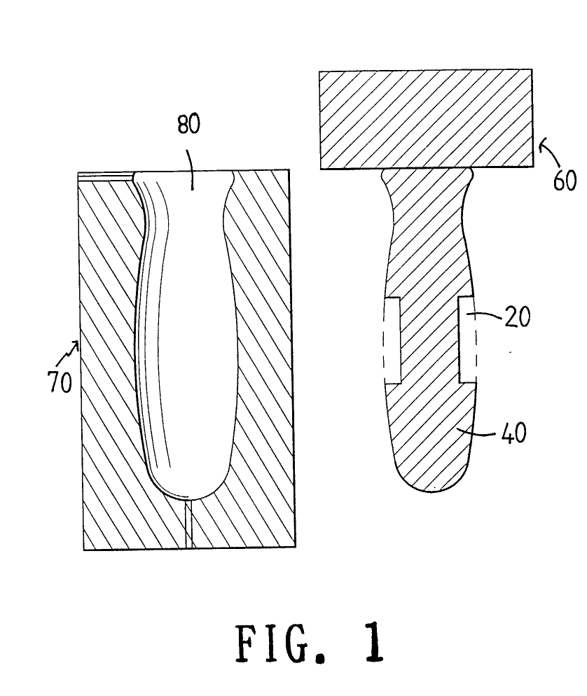

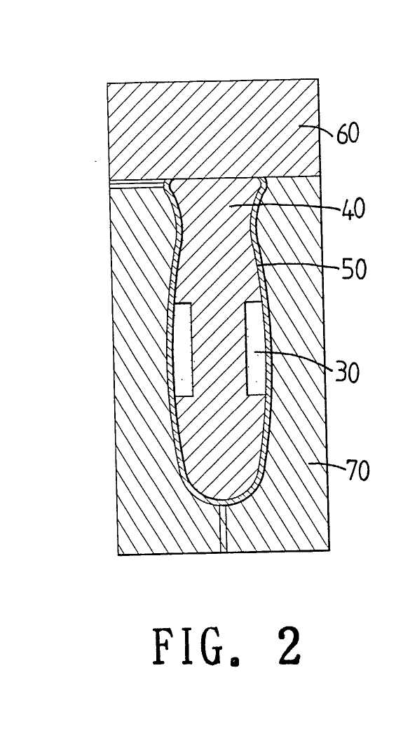

Referring to FIGS. 1 and 2, the handle 40 of a hand tool of the present invention comprises two recesses 20 defined in an outer periphery of the handle 40 and is connected to a male mold 60. A female mold 70 includes a concavity 80 which receives the handle 40 therein and a gap is defined between the inside of the concavity 80 and the handle 40. A magnetic piece 30 is received in each of the recesses 20. An outer layer 50 is formed by injecting proper material into the gap and the outer layer 50 is mounted to the handle 40 to enclose the handle 40 and the magnetic piece 30. By the outer layer 50, the magnetic pieces 30 are protected by the outer layer 50 and the color of the outer layer 50 can be made as desired.

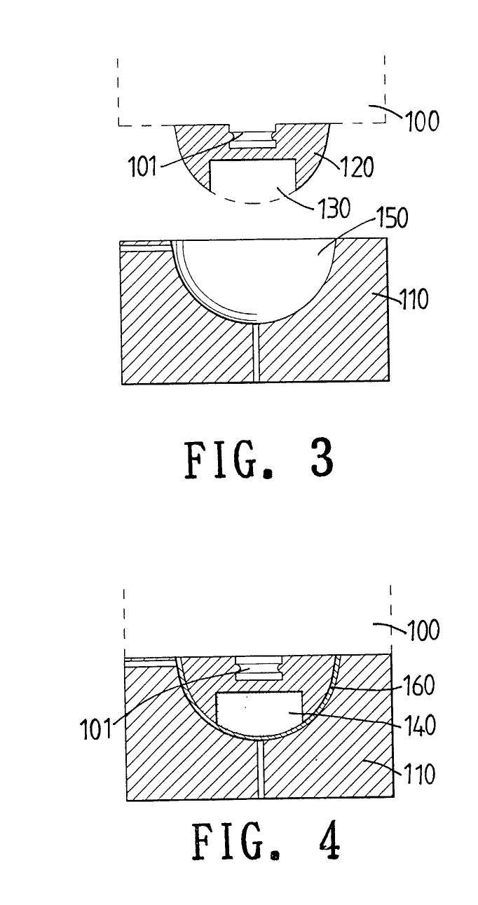

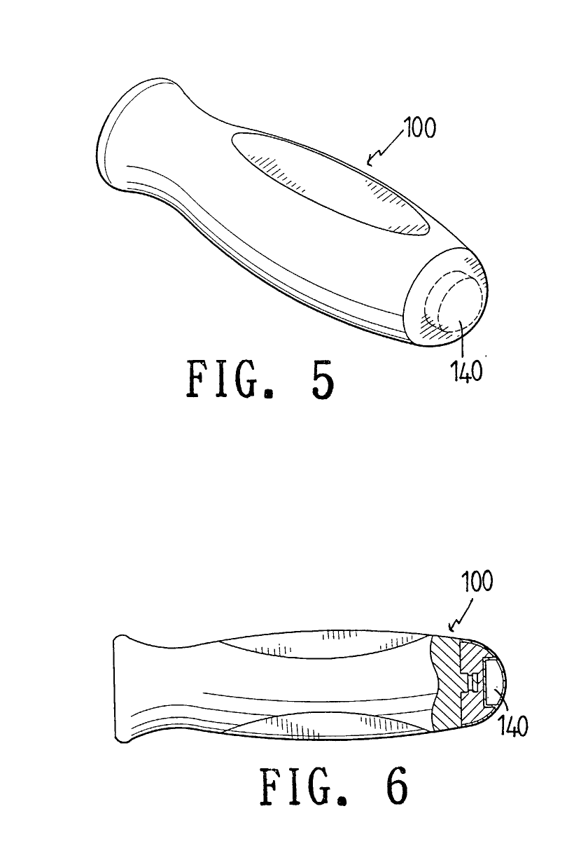

Referring to FIGS. 3 to 6, the magnetic piece 140 can also be located at the bottom of the handle 100. The handle 100 has a threaded rod 101 extending therefrom and an end cap 120 is connected to the threaded rod 101. A recess 130 is defined in the end cap 120 which is received in a concavity 150 defined in a female mold 110 with a gap defined between the inside of the concavity 150 and the end cap 120. An outer layer 160 is made by the same way as described relating to the FIG. 2 so as to enclose the end cap 120 and the magnetic piece 140.

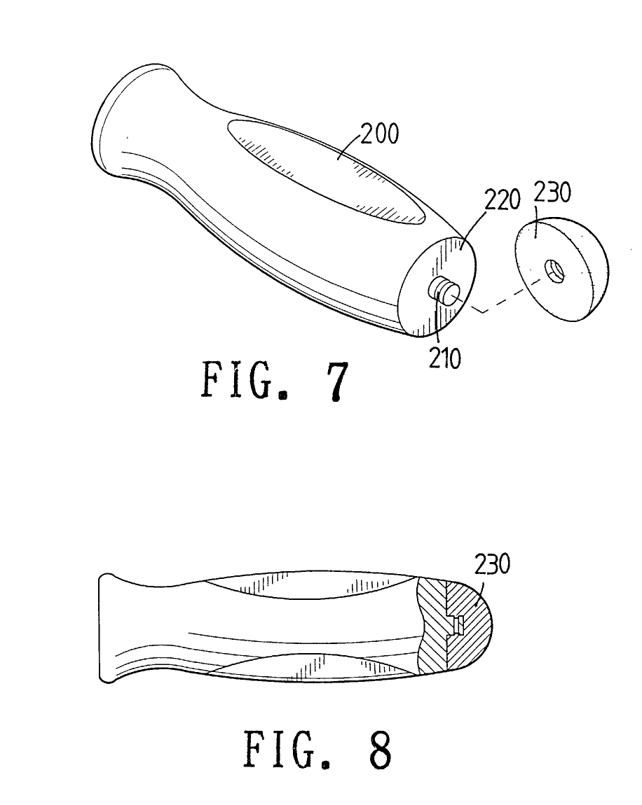

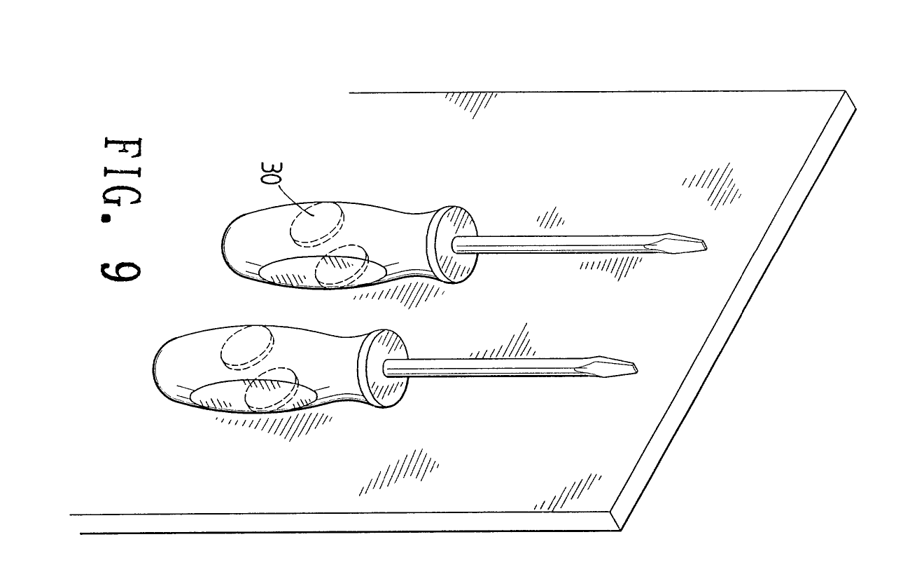

Referring to FIGS. 7 and 8, a threaded rod 210 extends from an end surface 220 of the handle 200 and a plastic magnetic piece 230 is threadedly connected to the threaded rod 210.

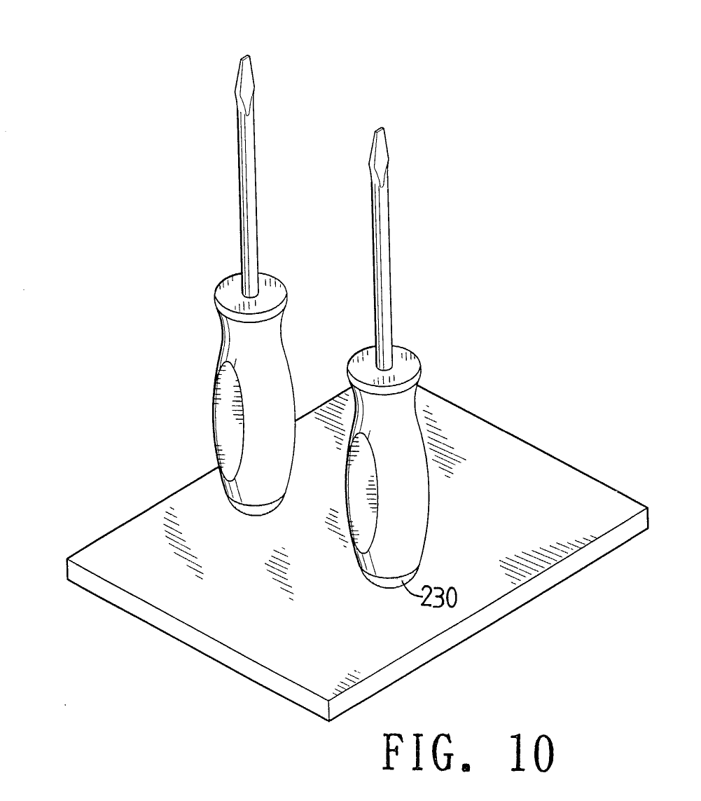

FIG. 9 shows that the handles can be attached on a metal board by their magnetic pieces 30 and FIG. 10 shows that the handles stand on a metal board by their magnetic pieces 230.

While we have shown and described the embodiment in accordance with the present invention, it should be clear to those skilled in the art that further embodiments may be made without departing from the scope of the present invention.

What is claimed is:

1. A handle of a hand tool, comprising:
at least one recess defined in an outer periphery of the handle and a magnetic piece received in the at least one recess, and
an outer layer mounted to the handle to enclose the handle and the magnetic piece.

2. A handle of a hand tool, comprising:
a threaded rod extending from the handle and at least one magnetic piece being threadedly connected to the threaded rod, and
an outer layer mounted to the handle to enclose the handle and the magnetic piece.

3. A handle of a hand tool, comprising:
a threaded rod extending from the handle 40 and an end cap being threadedly connected to the threaded rod, the end cap having a recess defined therein and a magnetic piece received in the recess, and
an outer layer mounted to the end cap to enclose the end cap and the magnetic piece.
